(19) United States
(12) Patent Application Publication
(10) Pub. No.: US 2026/0244292 A1
(43) Pub. Date: Aug. 20, 2026

(54) FORCE TOUCH PATTERN-INTEGRATED COVER GLASS MODULE AND DISPLAY DEVICE HAVING SAME

(71) Applicant: TOVIS CO., LTD., Incheon (KR)

(72) Inventors: Seung Kil HONG, Seoul (KR); Ho Dong KANG, Yongin-si Gyeonggi-do (KR)

(21) Appl. No.: 19/155,843

(22) PCT Filed: Nov. 17, 2023
(86) PCT No.: PCT/KR2023/018543

§ 371 Date: Aug. 12, 2025

(30) Foreign Application Priority Data
Feb. 17, 2023 (KR) 10-2023-0021449

(51) Int. Cl. G06F 3/041

(52) U.S. Cl. CPC G06F 3/04142; G06F 3/0416; G06F 2203/04105

(57) ABSTRACT

Disclosed are a force touch pattern-integrated cover glass module and a display device including the same. According to an embodiment of the present inventive concept, the force touch pattern-integrated cover glass module includes a cover glass arranged on one side of a touch display module driven in a touch type to protect the touch display module, a touch pattern portion provided on one surface of the cover glass facing the touch display module, and having a touch pattern that transmits a touch input signal to the touch display module when a menu pattern on the cover glass is touched, and a force pattern portion provided on one surface of the cover glass to be adjacent to the touch pattern portion, and having a force pattern that transmits a force input signal to the touch display module when a certain force is applied to the menu pattern on the cover glass.

### DESCRIPTION

### Technical Field

The present inventive concept relates to a force touch pattern-integrated cover glass module and a display device including the same, and more particularly, to a force touch pattern-integrated cover glass module, which may implement slimming of a device and remarkably increase force sensitivity compared with the relative art, and also contribute to reduction of material and manufacturing costs with a simple structure, and a display device including the force touch pattern-integrated cover glass module.

### Background Art

With the development of computers using digital technology, auxiliary devices of computers have been developed together, and personal computers, portable transmission devices, and other personal information processing devices may process text and graphics by using various input devices such as keyboards or mice.

However, interest in input device technologies has shifted beyond merely satisfying general functions, toward achieving higher reliability, durability, innovation, and design and processing related technologies. To fulfill such objectives, a touch panel has been developed as an input device capable of inputting information such as text and graphics.

Generally, a touch panel (or a touchscreen) has been diversely used as an information input device for an electronic device. Recently, a touch panel is widely used not only for PDAs including mobile phones, but also for most home appliances, such as MP3s, PMPs, PSPs, portable game devices, or navigation devices.

Recently known touch panels or touchscreens (hereinafter, referred to as the touch panel) largely include a resistive type and a capacitive type (a capacitive type, a resistive type, or an infrared type) depending on the operation method. A capacitive touch panel that is currently, widely being used adopts a method of receiving position information of a finger by detecting a current change on a panel when the finger comes into contact with the touch panel.

Meanwhile, as input information for recent touch panels, there is an increasing demand or need not only for simply two-dimensional coordinate information (X and Y), but also physical pressure information, that is, Z-axis input information. In line with this, research is actively underway to add a three-dimensional pressure device that detects pressure on the touch panel and the strength or degree of a pressing force. In other words, there are increasing attempts to add a force sensor to a display device with a touch sensor applied thereto.

As such, when a touch sensor and a force sensor are applied together to a display device, it is advantageous to prevent the display device from being driven by unintended touch operations. In other words, it is meaningful to apply the touch sensor and the force sensor together in that a certain amount of force needs to be applied to use a menu set on the display device by a touch type.

However, in applying the touch sensor and the force sensor together to a device, in the case of the related art, the touch sensor and the force sensor are separated, that is, the force sensor is individually assembled as a film type with a dual layer structure, and thus the volume of the device is bound to increase and the force sensitivity is bound to decrease as well.

Furthermore, in the case of the related art, as described above, as the touch sensor and the force sensor are separated in an individually assembled structure, for signal transmission from the respective sensors, a flexible printed circuit board (FPCB) need to be applied to each sensor. Accordingly, considering that the overall structure of the device is becoming more complex and the material cost is bound to increase, the need for a new concept display device to address this matter has arisen.

### DESCRIPTION OF EMBODIMENTS

### Technical Problem

Provided are a force touch pattern-integrated cover glass module which may implement slimming of a device and remarkably increase force sensitivity compared with the relative art, and also contribute to reduction of material and manufacturing costs with a simple structure, and a display device including the force touch pattern-integrated cover glass module.

### Advantageous Effects of Disclosure

According to the present inventive concept, the slimming of a device may be implemented and force sensitivity may be remarkably increased compared with the relative art, and also a simple structure may reduce material and manufacturing costs.

### BRIEF DESCRIPTION OF THE DRAWINGS

FIG. 1 is a perspective view of a display device according to an embodiment of the present inventive concept.

FIG. 2 is an exploded perspective view of FIG. 1.

FIG. 3 is an enlarged perspective view of a force touch pattern-integrated cover glass module illustrated in FIG. 2.

FIG. 4 is a perspective bottom view of FIG. 3.

FIG. 5 is a plan view of FIG. 4.

FIG. 6 is a schematic cross-sectional structural diagram according to an assembly state of FIG. 2.

FIG. 7 is a schematic connection structural diagram of a common FPCB.

FIG. 8 is a touch operational diagram for FIG. 7.

FIG. 9 is a control block diagram of a display device according to an embodiment of the present inventive concept.

### BEST MODE

According to an aspect of the present inventive concept, there is provided a force touch pattern-integrated cover glass module including a cover glass arranged on one side of a touch display module driven in a touch type to protect the touch display module, a touch pattern portion provided on one surface of the cover glass facing the touch display module, and having a touch pattern that transmits a touch input signal to the touch display module when a menu pattern on the cover glass is touched, and a force pattern portion provided on one surface of the cover glass to be adjacent to the touch pattern portion, and having a force pattern that transmits a force input signal to the touch display module when a certain force is applied to the menu pattern on the cover glass.

The force touch pattern-integrated cover glass module may further include a common flexible printed circuit board (FPCB) commonly connected to the touch pattern of the touch pattern portion and the force pattern of the force pattern portion, and commonly and selectively transmitting the touch input signal and the force input signal.

The common FPCB may be provided to extend to outside of the cover glass while being connected to the touch pattern and the force pattern

The force touch pattern-integrated cover glass module may further include a controller connected to the common FPCB and configured to control execution of a corresponding menu pattern based on the touch input signal or the force input signal transmitted through the common FPCB.

When the menu pattern is pressed and touched with a certain pressure, the controller may control execution of a corresponding menu pattern by primarily driving the touch pattern of the touch pattern portion and then secondarily driving the force pattern of the force pattern portion.

The force pattern may be arranged along an outer perimeter of the touch pattern.

The force pattern may have a loop shape with one side open.

A gap may be formed between the touch pattern and the force pattern to prevent the touch pattern and the force pattern from being connected to each other.

The touch pattern and the force pattern may be integrally formed on the cover glass.

The touch pattern and the force pattern may be formed on one surface of the cover glass in a single layer by a deposition process.

The cover glass may include a transparent window formed to be transparent while forming a center portion and exposing a part of the touch display module and an opaque window formed around the transparent window to be semi-transparent or opaque, in which the menu pattern includes a plurality of menu patterns.

According to another aspect of the present inventive concept, there is provided a display device including a set case forming an exterior structure, a touch display module coupled to the set case and driven in a touch type, and a force touch pattern-integrated cover glass module arranged on one side of the touch display module to protect the touch display module and inputting a touch signal to the touch display module, wherein the force touch pattern-integrated cover glass module includes a cover glass, a touch pattern portion provided on one surface of the cover glass facing the touch display module, and having a touch pattern that transmits a touch input signal to the touch display module when a menu pattern on the cover glass is touched, and a force pattern portion provided on one surface of the cover glass to be adjacent to the touch pattern portion, and having a force pattern that transmits a force input signal to the touch display module when a certain force is applied to the menu pattern on the cover glass.

A module arrangement recess portion in which the touch display module is placed may be formed inside the set case, and the touch display module and the force touch pattern-integrated cover glass module may be attached to each other via an optically clear adhesive (OCA) film.

A conductive polymer unit may be arranged between the set case and the force touch pattern-integrated cover glass module.

The display device may further includes a common FPCB commonly connected to the touch pattern of the touch pattern portion and the force pattern of the force pattern portion, and commonly and selectively transmitting the touch input signal and the force input signal, wherein the common FPCB is provided to extend to outside of the cover glass while being connected to the touch pattern and the force pattern.

The display device may further include a controller connected to the common FPCB and configured to control execution of a corresponding menu pattern based on the touch input signal or the force input signal transmitted through the common FPCB.

When the menu pattern is pressed and touched with a certain pressure, the controller may control execution of a corresponding menu pattern by primarily driving the touch pattern of the touch pattern portion and then secondarily driving the force pattern of the force pattern portion.

The force pattern may be arranged along an outer perimeter of the touch pattern, and the force pattern has a loop shape with one side open.

A gap may be formed between the touch pattern and the force pattern to prevent the touch pattern and the force pattern from being connected to each other, and the touch pattern and the force pattern may be integrally formed on one surface of the cover glass in a single layer by a deposition process.

The cover glass may include a transparent window formed to be transparent while forming a center portion and exposing a part of the touch display module, and an opaque window formed around the transparent window to be semi-transparent or opaque, in which the menu pattern includes a plurality of menu patterns.

### MODE OF DISCLOSURE

The attached drawings for illustrating preferred embodiments of the present inventive concept are referred to in order to gain a sufficient understanding of the present inventive concept, the merits thereof, and the objectives accomplished by the implementation of the present inventive concept.

Hereinafter, the present inventive concept will be described in detail by explaining preferred embodiments of the present inventive concept with reference to the attached drawings. Like reference numerals in the drawings denote like elements.

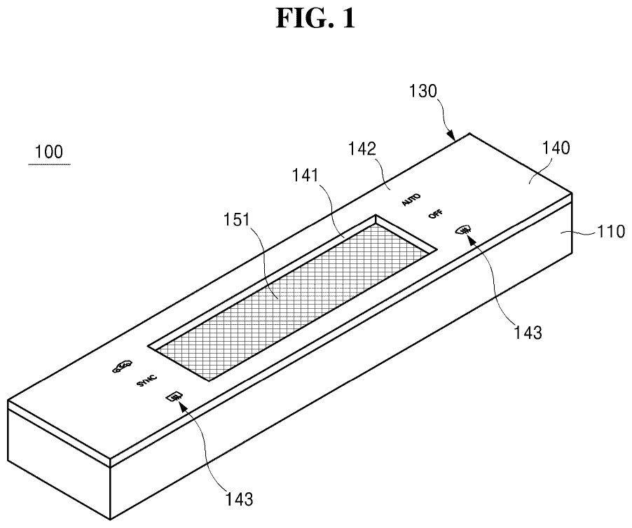

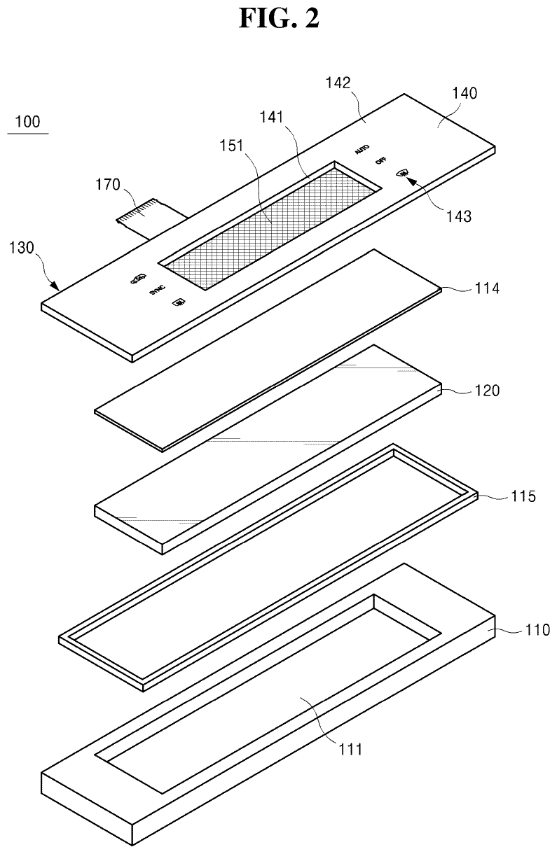

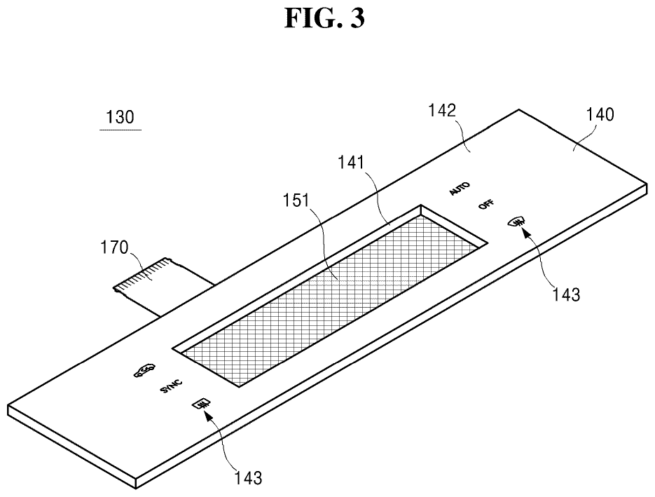

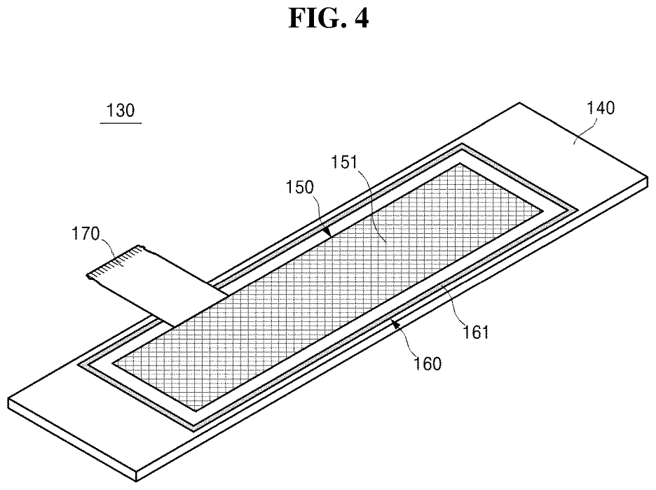

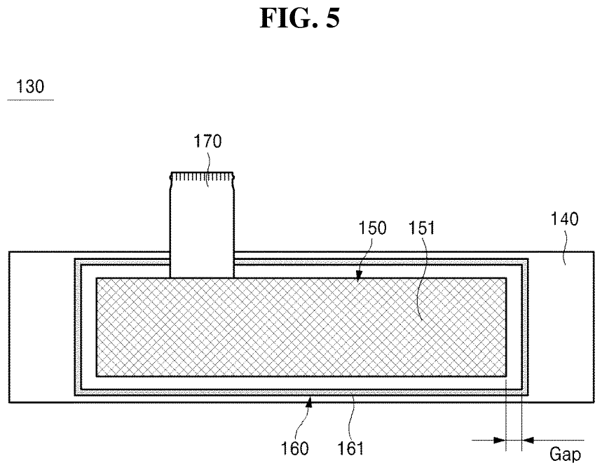

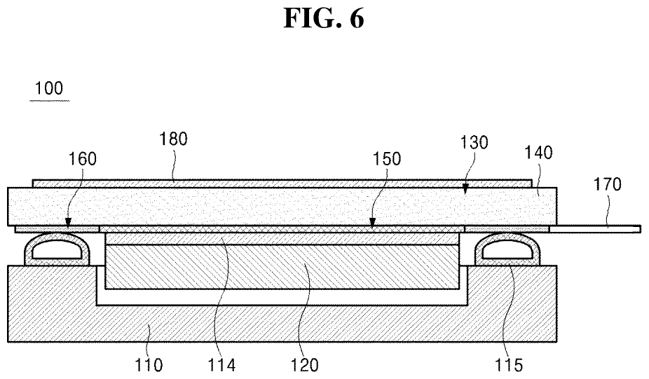

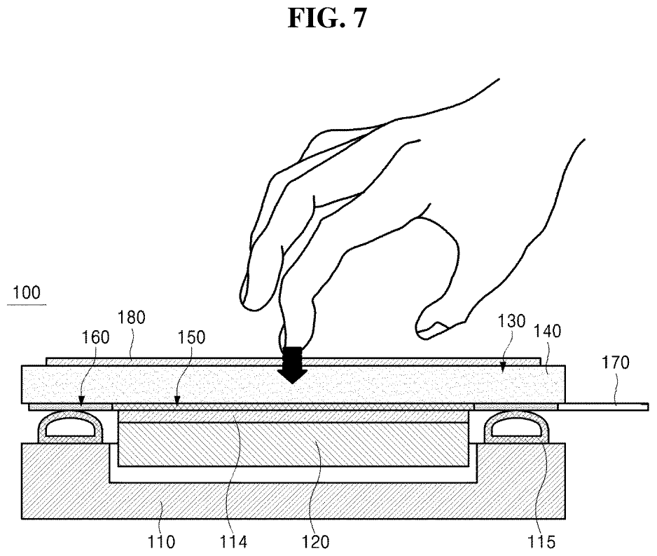

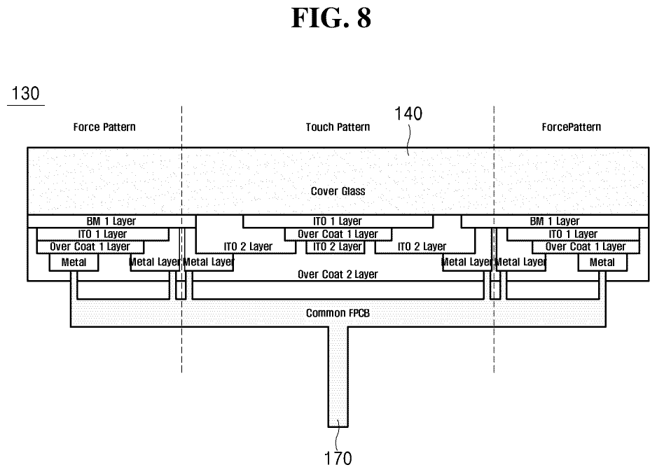

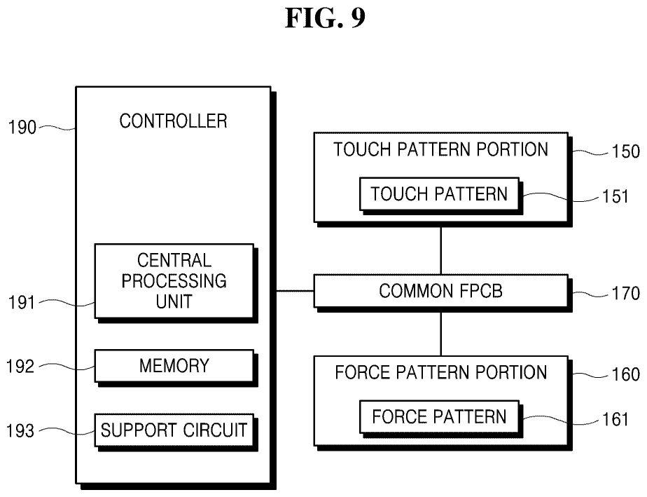

FIG. 1 is a perspective view of a display device according to an embodiment of the present inventive concept, FIG. 2 is an exploded perspective view of FIG. 1, FIG. 3 is an enlarged perspective view of a force touch pattern-integrated cover glass module illustrated in FIG. 2, FIG. 4 is a perspective bottom view of FIG. 3, FIG. 5 is a plan view of FIG. 4, FIG. 6 is a schematic cross-sectional structural diagram according to an assembly state of FIG. 2, FIG. 7 is a schematic connection structural diagram of a common FPCB, FIG. 8 is a touch operational diagram for FIG. 7, and FIG. 9 is a control block diagram of a display device according to an embodiment of the present inventive concept.

Referring to these drawings, the present inventive concept may implement slimming of a device and remarkably increase force sensitivity compared with the relative art, and also contribute to reduction of material and manufacturing costs with a simple structure.

The present inventive concept which can provide such effects may have the scope of rights applied to a force touch pattern-integrated cover glass module 130 and a display device 100 including the force touch pattern-integrated cover glass module 130. In the following description, an embodiment of the present inventive concept is described with an example of the display device 100 applied to cars.

The display device 100 according to the present embodiment may be, for example, a modular structure as illustrated in FIGS. 1 and 2, and have a structure in which a touch display module 120 and the force touch pattern-integrated cover glass module 130 are combined to a set case 110 by position. As described above, the display device 100 according to the present embodiment may be applied to cars. However, this is an example, but it is not necessarily applied to cars.

The set case 110 is an exterior structure of the display device 100 according to the present embodiment. The set case 110 may be installed on a dashboard of a car. For a neat exterior structure, the set case 110 may be installed to be embedded at a certain position on a dashboard of a car.

A module arrangement recess portion 111 is formed in the set case 110 that is injected in a block structure. The touch display module 120 may be coupled to the module arrangement recess portion 111 by being accommodated therein. Accordingly, the overall thickness of the display device 100 may be reduced, thereby contributing to slimming of the device.

The touch display module 120, which is a touch driven module, is assembled in the form of being accommodated and inserted in the module arrangement recess portion 111 of the set case 110, as described above. The force touch pattern-integrated cover glass module 130 is assembled on the touch display module 120.

In this state, the touch display module 120 and the force touch pattern-integrated cover glass module 130 may be attached to each other via an optically clear adhesive (OCA) film 114. The optically clear adhesive film 114 is a film that functions to remove light distortion phenomenon by increasing visibility of light, in addition to attaching the touch display module 120 and the force touch pattern-integrated cover glass module 130.

Meanwhile, the force touch pattern-integrated cover glass module 130, which is a part disposed on one side of the touch display module 120, inputs a touch signal to the touch display module 120 while protecting the touch display module 120.

The force touch pattern-integrated cover glass module 130 may include a cover glass 140, and a touch pattern portion 150 and a force pattern portion 160 disposed on the cover glass 140.

The cover glass 140 is an exterior structure of the force touch pattern-integrated cover glass module 130 and protects the touch display module 120. Finally, an anti-scattering film (ASF) 180 may be further attached on the cover glass 140. The application of the anti-scattering film 180 is optional.

The cover glass 140 may include a transparent window 141 forming a center portion and formed to be transparent, and an opaque window 142 formed around the transparent window 141 to be opaque.

A touch pattern 151 of the touch pattern portion 150 may be exposed in the transparent window 141. A plurality of menu patterns 143 are formed in the opaque window 142. The opacity of the opaque window 142 may include semi-transparency. The menu patterns 143 include specific icons.

As described above, as the display device 100 according to the present embodiment is applied to cars, the menu patterns 143 formed in the opaque window 142 of the cover glass 140 may be various car menu patterns 143 related to manipulation, operation, or activation of a car. In other words, the menu patterns 143 are the car menu patterns 143 such as a heating pattern or an air conditioning pattern. Accordingly, a user operates one pattern by touching a desired pattern 143 among the car menu patterns 143 on the cover glass 140. Unlike the above, when the display device 100 according to the present embodiment is applied to other devices or structures, not cars, the car menu patterns 143 may be changed to other patterns appropriate to the device.

The touch pattern portion 150 and the force pattern portion 160 are integrally formed on the cover glass 140. The touch pattern portion 150 and the force pattern portion 160 may be integrally formed on the cover glass 140 by a deposition method.

The touch pattern portion 150 is provided on one surface of the cover glass 140 facing the touch display module 120, and includes the touch pattern 151 that transmits a touch input signal to the touch display module 102 when the menu patterns 143 on the cover glass 140 are touched.

In addition, the force pattern portion 160 is provided on the one surface of the cover glass 140 adjacent to the touch pattern portion 150, and includes a force pattern 161 that transmits a force input signal to the touch display module 120 when a certain force is applied to the menu patterns 143 on the cover glass 140.

When the touch pattern 151 of the touch pattern portion 150 and the force pattern 161 of the force pattern portion 160 are integrally formed on the cover glass 140 of the display device 100 as in the present embodiment, the display device 100 may be prevented from being driven by an unintended touch operation. In other words, the menu patterns 143 on the display device 100 may be executed only when a certain level of a force is applied.

In more detail, in the case of the present embodiment, the menu patterns 143 are not executed in the form of slightly touching the menu patterns 143. In other words, as illustrated in FIG. 7, only when the menu patterns 143 are pressed and touched with a certain pressure, the touch pattern 151 of the touch pattern portion 150 is primarily driven, and then the force pattern 161 of the force pattern portion 160 is secondarily driven, thereby executing the menu patterns 143. In other words, as mentioned above, the menu patterns 143 are not executed in the form of slightly touching the menu patterns 143. Accordingly, the display device 100 may be prevented from being driven to activate by an unintended touch operation.

In particular, in the case of the present embodiment, unlike the related art, as the touch pattern 151 of the touch pattern portion 150 and the force pattern 161 of the force pattern portion 160 are integrally patterned on the cover glass 140, there is no need to take a separate structure as in the related art. Accordingly, in addition to contributing to the slimming of the device, there is an advantage in that force sensitivity is significantly improved compared to the related art. Moreover, as described below, as a common flexible printed circuit board (FPCB) 170 is applicable, a simple structure may contribute to reduction of material and manufacturing costs.

First, with respect to the touch pattern portion 150, in the present embodiment, the touch pattern portion 150 is provided on one surface of the cover glass 140 facing the touch display module 120, and includes the touch pattern 151 that transmits a touch input signal to the touch display module 120 when the menu patterns 143 on the cover glass 140 are touched. The touch pattern 151 has a larger range than the force pattern 161 of the force pattern portion 160.

In the present embodiment the touch pattern portion 150 adopts a capacitive touch (electrostatic touch) method. The capacitive type is a technology that operates by detecting a change in capacitance generated in a hand when the hand comes into contact, as shown in FIG. 7. In other words, in this method, as the human body is a conductor, when the menu pattern of the cover glass is pressed and touched with a finger, an electrostatic field of the cover glass changes, and then a processor of the device detects a location of the change.

As such, when the touch pattern portion 150 adopts the capacitive type, as the cover glass made of tempered glass is used as in the present embodiment, there are advantages such as resistance to scratches and enhanced visual clarity of the screen. Furthermore, as the capacitive type responds by detecting electrostatic charge at the fingertip, the type provides the advantage of a very high response speed.

Next, the force pattern portion 160 includes a force pattern 161 that is provided on one surface of the cover glass 140 to be adjacent to the touch pattern portion 150, and transmits a force input signal to the touch display module 120 when a certain force is applied to the menu patterns 143 on the cover glass 140. The force pattern portion 160 transmits a substantially force input signal with a conductive polymer unit 115.

In the present embodiment, the force pattern 161 is arranged along the outer perimeter of the touch pattern 151. In this state, the force pattern 161 forms a loop shape with one side open. This is because the common FPCB 170 is arranged in this side and then the touch pattern 151 and the force pattern 161 are connected to the common FPCB 170.

When the force pattern 161 is formed on the one surface of the cover glass 140, the touch pattern 151 and the force pattern 161 are not connected to each other. To this end, a gap G is formed between the touch pattern 151 and the force pattern 161.

For reference, in the case of the present embodiment, the touch pattern 151 is formed widely at the center portion of one surface of the cover glass 140 and the force pattern 161 is formed therearound. However, unlike the drawings, when an empty place is formed inside the touch pattern 151, the force pattern 161 may be formed therein. In other words, the scope of the present inventive concept is not limited to the shape of the drawings.

As repeatedly described, in the present embodiment, the touch pattern 151 and the force pattern 161 are integrally formed in the cover glass 140. In this state, the touch pattern 151 and the force pattern 161 may be formed on the one surface of the cover glass 140 in a single layer by a deposition process, and may be connected to the common FPCB 170.

Briefly discussing FIG. 8, the touch pattern 151 and the force pattern 161 may each include a plurality of indium tin oxide (ITO) layers and over coat layers, and a metal layer is connected to the common FPCB 170. In this state, unlike, an area of the touch pattern 151, a black matrix layer (BM layer) may be added to an area of the force pattern 161. The black matrix layer is a design element, and the opaque window 142 may be formed by the black matrix layer.

When the touch pattern 151 and the force pattern 161 are integrally formed by applying, that is, depositing, an ITO layer, an over coat layer, a metal layer, and a black matrix layer to the cover glass 140, as in the structure of FIG. 8, the cover glass 140 functions as a sensor so that an additional film, a sensor, or glass is unnecessary as before, and also an OCA or an OCR layer for an adhesive may be reduced so that very big advantages may be provided in terms of thickness and weight of a product.

The conductive polymer unit 115 is arranged between the set case 110 and the force touch pattern-integrated cover glass module 130. The conductive polymer unit 115 may be arranged in a strip shape along the outer perimeter of the set case 110 to correspond to the force pattern 161 formed on the cover glass 140, and may have a constant elasticity. Accordingly, as illustrated in FIG. 7, when the menu patterns 143 of the cover glass 140 are pressed, the conductive polymer unit 115 that is elastic is also pressed. In this state, the strength or level of a force or pressure applied to the cover glass 140 may be detected based on information according to an area change of the conductive polymer unit 115 or a distance change of the force pattern 161.

Meanwhile, as described above, in the case of the present embodiment, unlike the related art, as the touch pattern 151 of the touch pattern portion 150 and the force pattern 161 of the force pattern portion 160 are integrally patterned on the cover glass 140, there is no need to have a separate structure as in the related art. Accordingly, in addition to contributing to the slimming of the device, there is an advantage in that force sensitivity is significantly improved compared to the related art.

Moreover, different from the related art, the common FPCB 170 may be adopted. The common FPCB 170 is commonly connected to the touch pattern 151 of the touch pattern portion 150 and the force pattern 161 of the force pattern portion 160, as illustrated in FIGS. 8 and 9, and commonly selects and transmits the touch input signal and the force input signal.

While connected to the touch pattern 151 of the touch pattern portion 150 and the force pattern 161 of the force pattern portion 160 as illustrated in FIG. 8, the common FPCB 170 is provided to extend to the outside of the cover glass 140. In other words, the common FPCB 170 has one end portion that is connected to the metal layers of the touch pattern 151 and the force pattern 161, and the other end that extends to the outside of the cover glass 140 and is connected to a controller 190 of the device. The controller 190 is connected to the common FPCB 170, and controls execution of a corresponding one of the menu patterns 143 based on the touch input signal of the touch pattern portion 150 or the force input signal of the force pattern portion 160 transmitted via the common FPCB 170.

The controller 190 controls execution of a corresponding one of the menu patterns 143 by primarily driving the touch pattern 151 of the touch pattern portion 150 and then secondarily driving the force pattern 161 of the force pattern portion 160 when the menu pattern 143 is pressed and touched with a certain pressure as illustrated in FIG. 7. In other words, assuming that a heating menu is to be executed, the heating menu is not executed by slightly touching the heating menu among the menu patterns 143. In other words, only when the menu pattern 143 corresponding to the heating menu is pressed and touched with a certain pressure, the controller 190 controls execution of a corresponding one of the menu patterns 143 by primarily driving the touch pattern 151 of the touch pattern portion 150 and then secondarily driving the force pattern 161 of the force pattern portion 160.

The controller 190 that performs the above function may include a central processing unit (CPU) 191, a memory 192, and a support circuit 193.

The CPU 191 may be one of various computer processors that are industrially applicable to execute a corresponding one of the menu patterns 143 by primarily driving the touch pattern 151 of the touch pattern portion 150 and then secondarily driving the force pattern 161 of the force pattern portion 160 when the menu pattern 143 is pressed and touched with a certain pressure, in the present embodiment.

The memory 192 is connected to the CPU 191. The memory 192 may be installed locally or remotely as a computer-readable recording medium, for example, at least one memory that is easily usably such as random access memory (RAM), ROM, a floppy disk, a hard disk, or a certain digital storage form.

The support circuit 193 is combined with the CPU 191 to support a typical operation of a processor. The support circuit 193 may include cache, a power supply, a clock circuit, an input/output circuit, or a subsystem.

In the present embodiment, the controller 190 controls execution of a corresponding one of the menu patterns 143 by primarily driving the touch pattern 151 of the touch pattern portion 150 and then secondarily driving the force pattern 161 of the force pattern portion 160 when the menu pattern 143 is pressed and touched with a certain pressure, and such a series of control process may be stored in the memory 192. Typically, a software routine may be stored in the memory 192. The software routine may be stored or executed by another central processing unit (not shown).

Although the process according to the present inventive concept is described as being executed by a software routine, at least some of processes of the present inventive concept may be performed by hardware. As such, the processes of the present inventive concept may be implemented by software executed on a computer system, by hardware such as an integrated circuit, or by a combination of software and hardware.

Hereinafter, an operation of the display device 100 according to the present embodiment is described.

Assuming that, for example, a heating menu is to be executed among the menu patterns 143, the menu pattern 143 of the heating menu us touched. In this state, the corresponding menu is not executed only when a corresponding one of the menu patterns 143 is slightly touched.

In other words, only when the menu pattern 143 corresponding to the heating menu is pressed and touched with a certain pressure, as illustrated in FIG. 7, a corresponding one of the menu patterns 143 may be executed by primarily driving the touch pattern 151 of the touch pattern portion 150 and then secondarily driving the force pattern 161 of the force pattern portion 160.

According to the present embodiment operating with the structure described above, the slimming of the device may be implemented and the force sensitivity may be significantly improved compared to the related art, and furthermore material costs may be reduced with a simple structure.

While this inventive concept has been particularly shown and described with reference to preferred embodiments thereof, it will be understood by those of ordinary skill in the art that various changes in form and details may be made therein without departing from the spirit and scope of the inventive concept as defined by the appended claims. Therefore, the scope of the inventive concept is defined not by the detailed description of the inventive concept but by the appended claims, and all differences within the scope will be construed as being included in the present inventive concept.

### INDUSTRIAL APPLICABILITY

The present inventive concept may be used a display device that adopts a touch panel (or a touchscreen).

1. A force touch pattern-integrated cover glass module comprising:
a cover glass arranged on one side of a touch display module driven in a touch type to protect the touch display module;
a touch pattern portion provided on one surface of the cover glass facing the touch display module, and having a touch pattern that transmits a touch input signal to the touch display module when a menu pattern on the cover glass is touched; and
a force pattern portion provided on one surface of the cover glass to be adjacent to the touch pattern portion, and having a force pattern that transmits a force input signal to the touch display module when a certain force is applied to the menu pattern on the cover glass.

2. The force touch pattern-integrated cover glass module of claim 1, further comprising
a common flexible printed circuit board (FPCB) commonly connected to the touch pattern of the touch pattern portion and the force pattern of the force pattern portion, and commonly and selectively transmitting the touch input signal and the force input signal.

3. The force touch pattern-integrated cover glass module of claim 2, wherein the common FPCB is provided to extend to outside of the cover glass while being connected to the touch pattern and the force pattern.

4. The force touch pattern-integrated cover glass module of claim 3, further comprising
a controller connected to the common FPCB and configured to control execution of a corresponding menu pattern based on the touch input signal or the force input signal transmitted through the common FPCB.

5. The force touch pattern-integrated cover glass module of claim 4, wherein, when the menu pattern is pressed and touched with a certain pressure, the controller controls execution of a corresponding menu pattern by primarily driving the touch pattern of the touch pattern portion and then secondarily driving the force pattern of the force pattern portion.

6. The force touch pattern-integrated cover glass module of claim 1, wherein the force pattern is arranged along an outer perimeter of the touch pattern.

7. The force touch pattern-integrated cover glass module of claim 6, wherein the force pattern has a loop shape with one side open.

8. The force touch pattern-integrated cover glass module of claim 1, wherein a gap is formed between the touch pattern and the force pattern to prevent the touch pattern and the force pattern from being connected to each other.

9. The force touch pattern-integrated cover glass module of claim 1, wherein the touch pattern and the force pattern are integrally formed on the cover glass.

10. The force touch pattern-integrated cover glass module of claim 9, wherein the touch pattern and the force pattern are formed on one surface of the cover glass in a single layer by a deposition process.

11. The force touch pattern-integrated cover glass module of claim 1, wherein the cover glass comprises:
a transparent window formed to be transparent while forming a center portion and exposing a part of the touch display module; and
an opaque window formed around the transparent window to be semi-transparent or opaque, in which the menu pattern includes a plurality of menu patterns.

12. A display device comprising:
a set case forming an exterior structure;
a touch display module coupled to the set case and driven in a touch type; and
a force touch pattern-integrated cover glass module arranged on one side of the touch display module to protect the touch display module and inputting a touch signal to the touch display module,
wherein the force touch pattern-integrated cover glass module comprises:
a cover glass;
a touch pattern portion provided on one surface of the cover glass facing the touch display module, and having a touch pattern that transmits a touch input signal to the touch display module when a menu pattern on the cover glass is touched; and
a force pattern portion provided on one surface of the cover glass to be adjacent to the touch pattern portion, and having a force pattern that transmits a force input signal to the touch display module when a certain force is applied to the menu pattern on the cover glass.

13. The display device of claim 12, wherein
a module arrangement recess portion in which the touch display module is placed is formed inside the set case, and
the touch display module and the force touch pattern-integrated cover glass module are attached to each other via an optically clear adhesive (OCA) film.

14. The display device of claim 12, wherein
a conductive polymer unit is arranged between the set case and the force touch pattern-integrated cover glass module.

15. The display device of claim 12, further comprising
a common flexible printed circuit board (FPCB) commonly connected to the touch pattern of the touch pattern portion and the force pattern of the force pattern portion, and commonly and selectively transmitting the touch input signal and the force input signal,
wherein the common FPCB is provided to extend to outside of the cover glass while being connected to the touch pattern and the force pattern.

16. The display device of claim 15, further comprising
a controller connected to the common FPCB and configured to control execution of a corresponding menu pattern based on the touch input signal or the force input signal transmitted through the common FPCB.

17. The display device of claim 16, wherein,
when the menu pattern is pressed and touched with a certain pressure, the controller controls execution of a corresponding menu pattern by primarily driving the touch pattern of the touch pattern portion and then secondarily driving the force pattern of the force pattern portion.

18. The display device of claim 12, wherein
the force pattern is arranged along an outer perimeter of the touch pattern, and the force pattern has a loop shape with one side open.

19. The display device of claim 12, wherein
a gap is formed between the touch pattern and the force pattern to prevent the touch pattern and the force pattern from being connected to each other, and
the touch pattern and the force pattern are integrally formed on one surface of the cover glass in a single layer by a deposition process.

20. The display device of claim 12, wherein the cover glass comprises:
a transparent window formed to be transparent while forming a center portion and exposing a part of the touch display module; and
an opaque window formed around the transparent window to be semi-transparent or opaque, in which the menu pattern includes a plurality of menu patterns.
